(19) United States
(12) Patent Application Publication
(10) Pub. No.: US 2006/0179126 A1
(43) Pub. Date: Aug. 10, 2006

(54) Remote downloading system, managing apparatus, data receiving apparatus, operation apparatus, information processing apparatus and computer readable information recording medium

(75) Inventors: Satsuki Fujino, Kawasaki (JP); Tsutomu Tomomatsu, Kawasaki (JP); Tetsuya Kanekon, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/156,667

(22) Filed: Jun. 21, 2005

(30) Foreign Application Priority Data
Feb. 10, 2005 (JP) 2005-035223

(51) Int. Cl. G06F 15/16

(52) U.S. Cl. 709/219

(57) ABSTRACT

In a remote downloading system, a data utilization apparatus downloads data from a data delivery apparatus by an operation of the operation apparatus, the operation apparatus is thus applied to obtain downloading information required for downloading the data from the data delivery apparatus, and transmits the thus-obtained downloading information to the data utilization apparatus, and the data utilization apparatus applies the downloading information thus transmitted from the operation apparatus to download the relevant data from the data delivery apparatus.

### BACKGROUND OF THE INVENTION

1. Field of the Invention

The present invention relates to a remote downloading system, a managing apparatus, a data receiving apparatus, an operation apparatus, an information processing apparatus and a computer readable information recording medium, and more particularly, to a remote downloading system, a managing apparatus, a data receiving apparatus, an operation apparatus, an information processing apparatus and a computer readable information recording medium, for realizing a system for downloading data in a remotely located information processing apparatus, via a communication network such as the Internet.

2. Description of the Related Art

Contents such as an image, a music, software or such is downloaded in an information processing apparatus using a communication network such as the Internet. However, when a data size of the contents to download is large, a considerable time may be required for completing download of the contents.

The following patent documents disclose the related arts:

[patent document 1]

Japanese Laid-Open Patent Application No. 2003-50919;

[patent document 2]

Japanese Laid-Open Patent Application No. 2002-7742;

[patent document 3]

Japanese Laid-Open Patent Application No. 2001-325468; and

[patent document 4]

Japanese Laid-Open Patent Application No. 2001-346270.

### SUMMARY OF THE INVENTION

A case is assumed where a user is at a position apart from an information processing apparatus in which data such as the contents is downloaded and utilized, i.e., for example, the data is downloaded and is utilized at home, while the user oneself goes out when the download is actually carried out. In such a case, the following procedure is conceivable. That is, during a spare time of the user, predetermined operation actually required for downloading the data is carried out with the use of an operation apparatus (for example, a cellular telephone, a PDA, a personal computer or such) which is different from the above-mentioned information processing apparatus at home. Thereby, the data can be downloaded in the above-mentioned information processing apparatus located at home. If such a method is realized, downloading operation has been already completed before the user reaches home in which the information processing apparatus with which the data thus downloaded are actually utilized. Therefore, it is possible to eliminate a waiting time otherwise required for the downloading operation.

The present invention has been devised to realize such an environment. An object of the present invention is to provide a system enabling download of data in an information processing apparatus, by operation from a position apart from the information processing apparatus itself in which the data is actually downloaded, and with which the thus-obtained data is utilized by the user.

In order to achieve this object, according to the present invention, a predetermined operation apparatus is applied to obtain predetermined downloading information required for actually downloading relevant data from a data delivery apparatus. Then, the thus-obtained downloading information is transmitted to a data utilization apparatus (corresponding to the above-mentioned information processing apparatus located at home). The data utilization apparatus downloads the relevant data from the data delivery apparatus with the use of the thus-obtained downloading information.

By such a configuration, the user can positively perform the operation, required for downloading the data, to the data delivery apparatus with the operation apparatus at hand. In addition, actual downloading instructions can be sent to the data delivery apparatus from the operation apparatus at hand, with the use of the above-mentioned downloading information obtained by means of the above-mentioned operation. Accordingly, it is possible to avoid information leaks.

### BRIEF DESCRIPTION OF THE DRAWINGS

Other objects and further features of the present invention will become more apparent from the following detailed description when read in conjunction with the accompanying drawings:

FIG. 1 shows a system block diagram of a remote downloading system according to a first embodiment of the present invention.

FIG. 2 shows a flow chart showing operation in a purchase phase in the remote downloading system shown in FIG. 1;

FIG. 3 shows a flow chart showing operation in a download instruction phase in the remote downloading system shown in FIG. 1;

FIG. 4 shows a flow chart showing operation in a downloading phase in the remote downloading system shown in FIG. 1.

FIG. 5A shows a flow chart and FIG. 5B shows a mail format, illustrating production of an instruction electronic mail (setting of necessary information there) in the remote downloading system shown in FIG. 1;

FIG. 6 shows a flow chart showing reception of the instruction electronic mail in the remote downloading system shown in FIG. 1, and analysis operation therefor;

FIGS. 7, 8 and 9 show a flow chart showing download processing operation in the remote downloading system shown in FIG. 1;

FIG. 10 shows a system block diagram of a remote downloading system according to a second embodiment of the present invention;

FIG. 11 shows a flow chart showing operation in a purchase phase in the remote downloading system shown in FIG. 10;

FIG. 12 shows a flow chart showing operation in a download instruction phase in the remote downloading system shown in FIG. 10;

FIG. 13 shows a flow chart showing operation in a downloading phase in the remote downloading system shown in FIG. 10;

FIG. 14 shows a flow chart showing operation in a purchase phase in a remote downloading system according to a third embodiment of the present invention;

FIG. 15 shows a flow chart showing operation in a download instruction phase in the remote downloading system according to the third embodiment of the present invention;

FIG. 16 shows a flow chart showing operation in a downloading phase in the remote downloading system according to the third embodiment of the present invention; and

FIG. 17 shows a block diagram of a hardware configuration of an instruction terminal, each server and a content utilization terminal included in the remote downloading system according to each embodiment of the present invention.

### DETAILED DESCRIPTION OF THE PREFERRED EMBODIMENTS

For example, a case is assume in which, in an Internet shopping occasion, a user purchases the contents such as an image, a music, software or such, and downloads the same, to be utilized in a personal computer located at home. In such a case, according to the related art, actual downloading is started after the necessary procedure is completed on the personal computer on which the contents will be utilized. However, in such a case, a considerable time may be required for the completion of actual downloading when a data size of the contents is so large, and the user may feel troublesome to wait therefor.

According to embodiments of the present invention, by previously introducing a home network system or such at home, it is possible to send instructions for downloading the contents to a designated personal computer located at home previously, as a result of carrying out operation on another personal computer, a cellular phone, or such at a position apart from home. As a result, the user should not wait for a time actually required for downloading the contents. In fact, the user can immediately utilize the contents, such as an image, a music, software, or such, which have been thus already downloaded before the user come back home.

In order to achieve such an environment, according to the embodiments of the present invention, a procedure of obtaining the contents is started from a remote position with the use of another personal computer, a PDA, a cellular phone or such, at a beginning of the Internet shopping. Then, after this procedure is finished, the user accesses a home server of home, and sends instructions for actually starting download of the contents from a predetermined service providing source. At this time, the system is configured such that, the service providing source sends an electronic mail to the user, after the completion of the above-mentioned procedure, which mail includes a service commencement notification, a password, license key information and so forth, which are required for actually utilizing the contents after being downloaded. By applying the thus-obtained information (referred to as ‘downloading information’), personal authentication can be made, and, with the use thereof, the user may immediately utilize the service from the contents thus downloaded in the personal computer when the user comes back home.

Thus, according to the embodiment of the present invention, when the user wishes to download and utilize data through the Internet or such, it is possible to download the data in a designated personal computer or such from a position apart therefrom with the use of another personal computer, a PDA, a cellular phone or such, without actually applying the personal computer in which the data is downloaded.

The present invention can also be applied to a situation in which many users operate their own personal computers respectively, i.e., for example, in a public facility such as a school, a library, or such. In such a situation, many users may share common software or such with the use of personal computers, respectively. In such a case, one personal computer should be applied to carry out a necessary procedure for the Internet shopping, for example. Then, after that, actual downloading of the data is carried out by the following steps, for example: That is, first, the personal computer which thus completed the necessary procedure for the Intent shopping transfers necessary information to each of the other respective personal computers in the facility, and also, sends instruction information for causing the respective personal computers to actually download the relevant data/contents. As a result, it is possible to cause the personal computer of each user to actually download the data/contents.

In this case, instead of causing the personal computer of each user to carry out the download one by one, the following scheme may be provided: That is, the respective terminals (personal computers) are connected by means of a LAN (local area network) or such, a mother server is provided therefor, which server takes a part of actually carrying out download as a representative, and after that, the thus-obtained contents may be delivered to the personal computer of each user from the mother server at an arbitrary timing.

Thus, according to the embodiments of the present invention, it is possible to achieve advance download of the contents by means of operation from a remote position, and thus, it is possible to eliminate a waiting time otherwise required for downloading even a large size of the contents or such until a relevant service can be actually utilized therefrom. Therefore, the user is prevented from being reluctant to actually purchase a service even if a large size of data is required, and thus, it is possible to provide an environment in which the user can casually utilize various sorts of on-line services.

The embodiments of the present invention are described in detail with reference to figures, below:

A first embodiment of the present invention is described now.

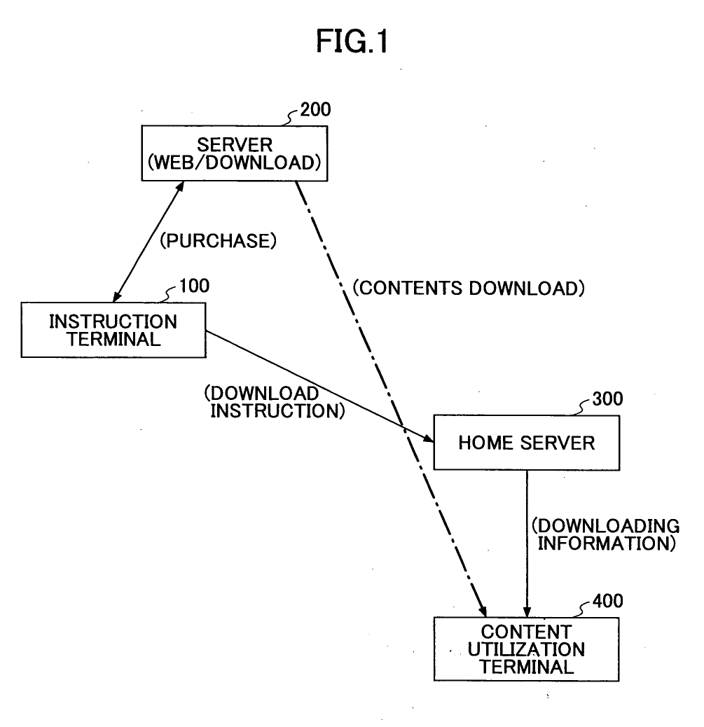

FIG. 1 is a block diagram showing a configuration of a remote downloading system according to the first embodiment of the present invention.

As shown, the remote downloading system includes a content delivery server 200; an instruction terminal 100 (for example, a cellular telephone, a PDA, a personal computer or such) with which a content purchase procedure as an electronic commerce transaction is carried out by a user with the use of an electronic mail; a home server (corresponding to a management server) 300 of a home network provided at home of the user; and a content utilization terminal (a personal computer or such) 400 as a household electrical appliance connected to the home server 300 via the home network.

These parts (apparatuses) are connected via an information communication network such as the Internet mutually, such that they are mutually communicatable by means of electronic mails or such. In addition, another environment is provided such that the home server 300 and the content utilization terminal 400 included in the home network are mutually communicatable by LAN or such.

Outline operation of the remote downloading system according to the embodiment of the present invention is as follows.

The user now going out carries out a procedure for purchasing desired contents (music, video, software or such) by accessing the content delivery server 200 via the Internet or such, on the instruction terminal 100 such as a cellular phone carried by the user, with the use of a spare time, for example. That is, by a way such as electronic commerce, an electronic mail is applied as a communication medium, and desired contents are purchased (a purchase phase) with the use thereof, for example. It is noted that currently only the purchase procedure is carried out, and actual download of the contents is not carried out yet.

As a result of this purchase procedure, the user obtains information (which is necessary for actual download of the contents from the server 200, and is referred to as downloading information, as mentioned above), this is transmitted via an electronic mail for the home server 300 at the empty home of the user. The home server 300 which has thus received this turns on power supply of the content utilization terminal 400 also provided in the empty home under the control of the own machine, and obtains, from the content utilization terminal 400, information concerning an available storage capacity of a hard disk thereof. It is noted that, it is assumed that power supply of the home server 300 is always turned on even in such a user-absent state. As a result, when it has been confirmed that the available storage capacity is enough, the home server 300 sends the content utilization terminal 400 the downloading information and instruction information including an order to start actual download of the contents (download instruction phase).

The content utilization terminal 400 thus having received them accesses the content delivery server 200 based on the downloading information, and gives content delivery instructions thereto after passing through necessary procedure. The content delivery server 200 having received the instructions starts delivery of the relevant contents to the content utilization terminal 400 via the information communication network (download phase).

Thus, download processing of the contents which the user has purchased by means of the instruction terminal 100 is automatically executed in the content utilization terminal 400 in the empty home. As a result, the download processing should have been completed when the user comes back home. Further, it is noted that the user already has received license key information required for actually utilizing the thus-downloaded contents, via an electronic mail at the time of the completion of the above-mentioned procedure of purchasing the contents carried out by means of the instruction terminal 100. Therefore, the user, after coming back home, can immediately utilize the relevant contents on the content utilization terminal 400 with the use of the license key information thus received. As a result, the user should not sense a troublesome of a waiting time actually required for the download of the contents, and thus, it is possible to improve the convenience in such content purchase service.

Processing, to be carried out automatically by the content utilization thermal 400 in the empty home, is not limited to the download processing. The content utilization terminal 400 may also be caused to automatically carry out installing processing for software, when the thus-downloaded contents are software, for example, subsequent to the download processing. As a result, it is possible to further improve the convenience in such content purchase service.

The details of operation of each phase in the remote downloading system, generally described above, are described now.

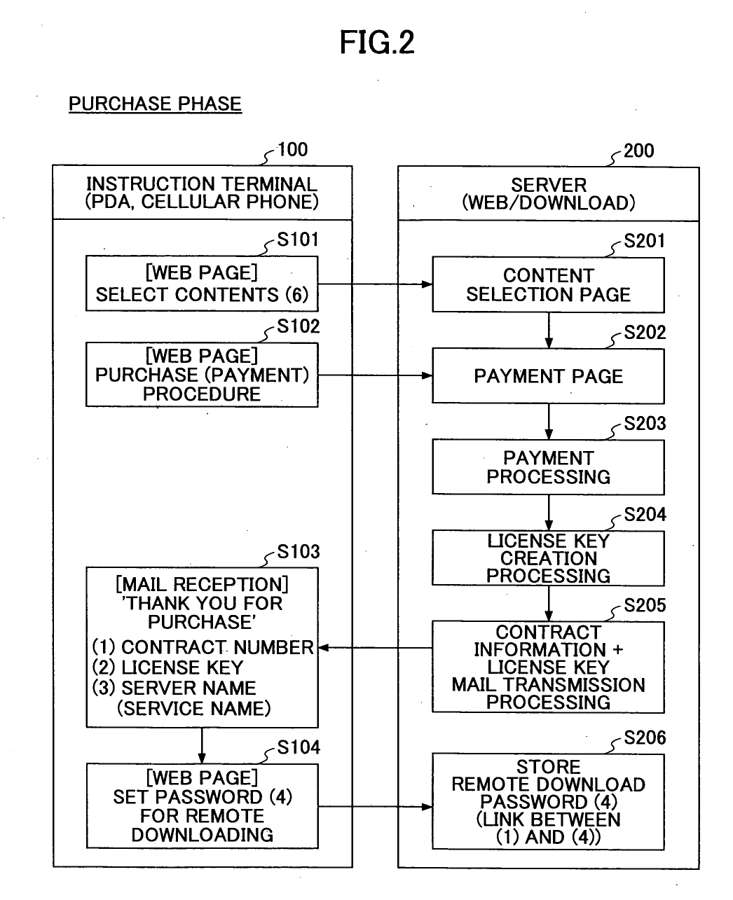

First, the purchase phase is described with reference to FIG. 2. The user accesses a Web site of the content delivery server 200 by means of the instruction terminal 100 in the phase, desired contents are selected (Step S101) on a predetermined content selection page (Step S201). Next, an actual purchase procedure is carried out (Step S102) on a payment page (Step S202), and the content delivery server 200 which has received this operation complete the payment processing (Step S203). As a result, the content delivery server 200 creates license key information for the contents thus purchased by the user in the payment processing (Step S204). Then, the content delivery server 200 transmits order information and the license key information to the instruction terminal 100 of the user who is a customer of the transaction, by an electronic mail (Step S205). An order number, the license key information and a pertinence server (service) name are included in the information thus transmitted.

The user who has received this on the instruction terminal 100 carries out operation on the instruction terminal 100 for setting a password necessary for actually downloading the thus-purchased contents and sending it to the content delivery server 200 (Step S104). The content delivery server 200 having received the set password operation stores it in such a manner to provide a linkage of the password with the above-mentioned order number (Step S206).

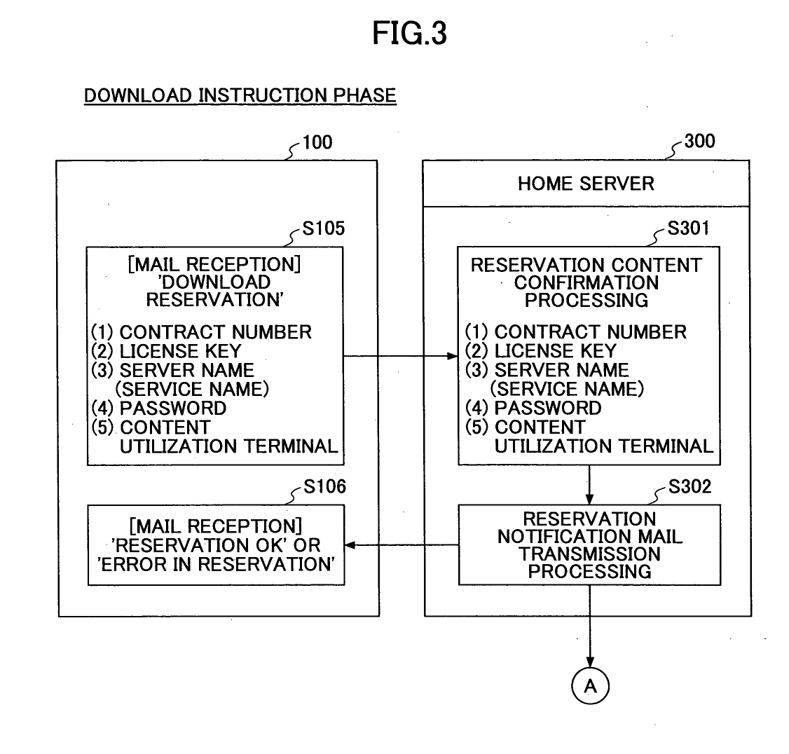

Next, the download instruction phase is described with reference to FIG. 3. The user who has thus made the purchase procedure for the contents in the purchase phase transmits the downloading information including an order to start download processing, via an electronic mail for the home server 300 of the empty home, by means of the instruction terminal 100 (Step S105). The information transmitting to the home server 300 at this time includes the order number, the license key information, the server name (service name), the password and information to identify the content utilization terminal 400 which actually carries out download operation.

The home server 300 which has received this information recognizes the same (Step S301), and returns therefor an acknowledgement signal to the instruction terminal 100 indicating a sure reception of the relevant information (Step S302). In the instruction terminal 100 which has received the acknowledgement displays the same on a display device thereof (Step S106).

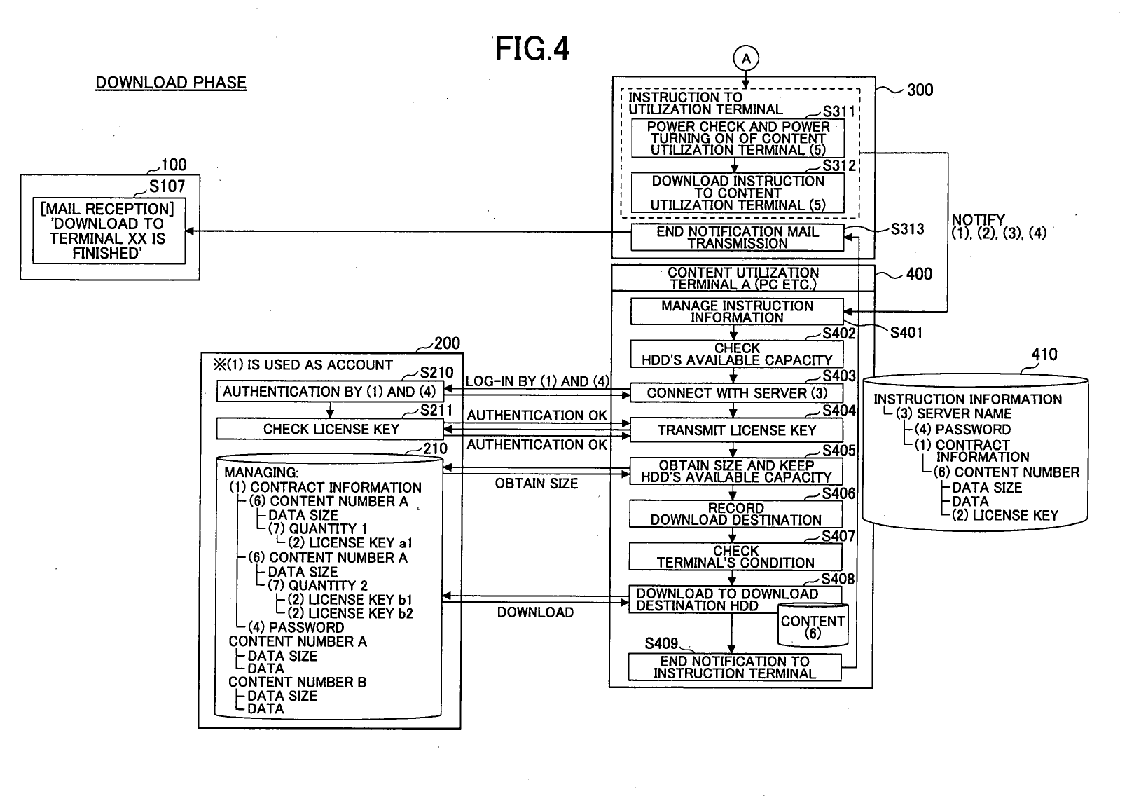

Next, with reference to FIG. 4, the download phase is described. The home server 300 which has thus received the downloading information in the above-described download instruction phase determines whether power supply of the content utilization terminal 400 designated in the received information is turned on. If not, the home server 300 turns on the power of the content utilization terminal 400 (Step S311). Then, the home server 300 transmits the downloading information to the content utilization terminal 400 which has been thus started up so as to enter an operable state (Step S312). The downloading information includes instructions to start download processing, the order number, the license key information, the server name (a service name) and the password.

The downloading information transmitted as mentioned above is managed in a storage device 410 in the content utilization terminal 400 (Step S401). Next, the content utilization terminal 400 checks its own available storage capacity in a hard disk (Step S402). As a result, if the available storage capacity is sufficient, the content utilization terminal 400 accesses the relevant content delivery server 200 (i.e., actually, URL of the server, or such), identified by the server name included in the thus-managed downloading information (Step S403). At this time, Login operation is carried out by applying the order number and the password included in the downloading information.

Authentication processing is thus carried out in the content delivery server 200 in response to the Login operation, and the Login is accepted (Step S210). The content utilization terminal 400 then transmits the license key information included in the downloading information to the content delivery server 200 in the same way afterwards (Step S404), and the content delivery server 200 which has thus received it checks the license key information (Step S211). As a result, authentication processing for the content delivery destination is completed in the server 200.

Next, a size of the contents that are going to be downloaded is obtained from the content delivery server 200 by the content utilization terminal 400 (Step S405), which then carries out processing to keep a storage area in the hard disk necessary to store the relevant contents.

In addition, information that is necessary for each contract of transaction obtained as a result of the purchase procedure by each user is managed in a storage device 210 in the content delivery server 200. A content number concerning each purchase, a data size, a contract quantity, license key information, a password set by a user and so forth are included in the managed information.

Next, in the content utilization terminal 400, an address of a storage area in the hard disk as a download destination secured as mentioned above is recorded (Step S406), a state of own machine is checked (Step S407) as to whether or not any problem exists. Actual download is actually when no particular problem is detected as a result (Step S408).

When the download of the contents is completed, this matter is notified of to the home server 300 by the from content utilization terminal 400 (Step S409). The home server 300 which has received this transmits an end notice by an electronic mail to the instruction terminal 100 of the user (Step S313). The instruction terminal 100 which has received this notifies the user of this matter by displaying the information on its display device (Step S107).

Then, when the user comes back home, the user actually utilizes the contents thus downloaded in the content utilization terminal 400. At this time, instruction information (the license key information, for example) managed in the storage device 410 is applied, and, in the content utilization terminal 400, it is determined whether or not usage of the contents by the user is allowable. Then the user who currently operates the content utilization terminal 400 is the authorized user, usage of the contents is allowed as a result of the license key information, received in the purchase phase shown in FIG. 2, being input. On the other hand, since another user do not have the relevant license key information, usage by another user is not allowed even when the downloaded is made in a terminal of the other user by mistake.

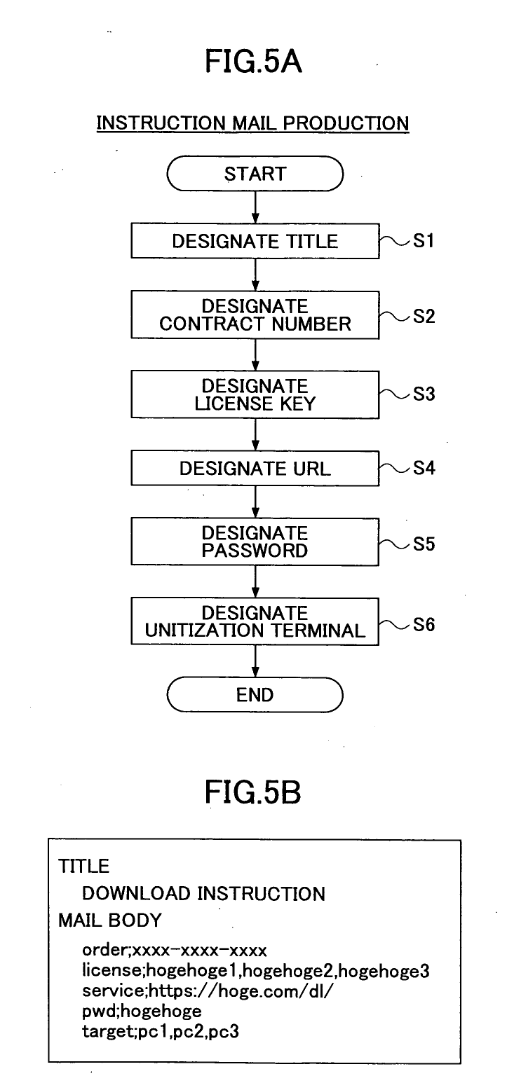

Next, with reference to FIGS. 5A and 5B, ‘transmission of the instruction electronic mail’ in Step S105 shown in FIG. 3 mentioned above is described in detail. A format of the instruction electronic mail transmitted to the home server 300 from the instruction terminal 100 is shown in FIG. 5B.

As shown in the format, “download instructions” (fixed) is designated as a title of the electronic mail (Step S1, FIG. 5A). Next, in the electronic mail body, after “order;”, the order number issued by the service providing source at the time of the content purchase procedure is put (Step S2). Then, after “license;”, the license key information that the service providing source has issued at the time of the content purchase procedure is put (Step S3). Next, after “service;”, the URL that the service providing source has provided at the time of the content purchase procedure is put (Step S4). Then, after “pwd;”, the password set for the remote download is put (Step S5). Last, after “target;”, the terminal name of the user's content utilization terminal is put (Step S6). This terminal name should be previously defined in the home server 300.

In addition, the license key information is provided for each title of purchased contents (two are issued when the same title is purchased twice, for example), and the number of the license key information, corresponding to the respective titles, are listed after “license;” (as shown in FIG. 5B).

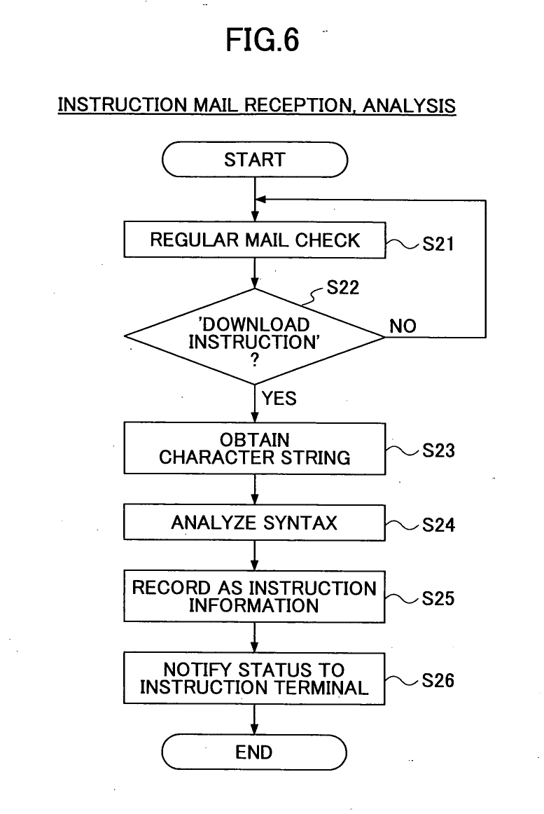

Next, with reference to FIG. 6, reception and analysis of the instruction electronic mail transmitted from the instruction terminal 100 in the home server 300 shown in FIG. 3 are described. It is assumed that a predetermined download instruction electronic mail processing program is resident in the home server 300. According to a function of this program, the home server 300 checks electronic mails coming regularly, and analyzes the same when it has the tile of “download instructions” (Steps S21, S22, S23).

A basic sentence structure of the instruction electronic mail, for each line, is ‘“command”+“;” (delimiter) +“parameter” (,parameter)’, and the order among the respective items, i.e., license, service, pwd and target is not limited to the stated order. The program obtains the character string every line, the sentence structure analysis is then carried out, and the analysis result is recorded as the instruction information (Steps S23, S24, S25).

Then, to an electronic mail address of the instruction terminal 100, an electronic mail is transmitted in which a status of the mail is set as a character string of “reservation ok” or “error in reservation” in a mail body thereof (Step S26).

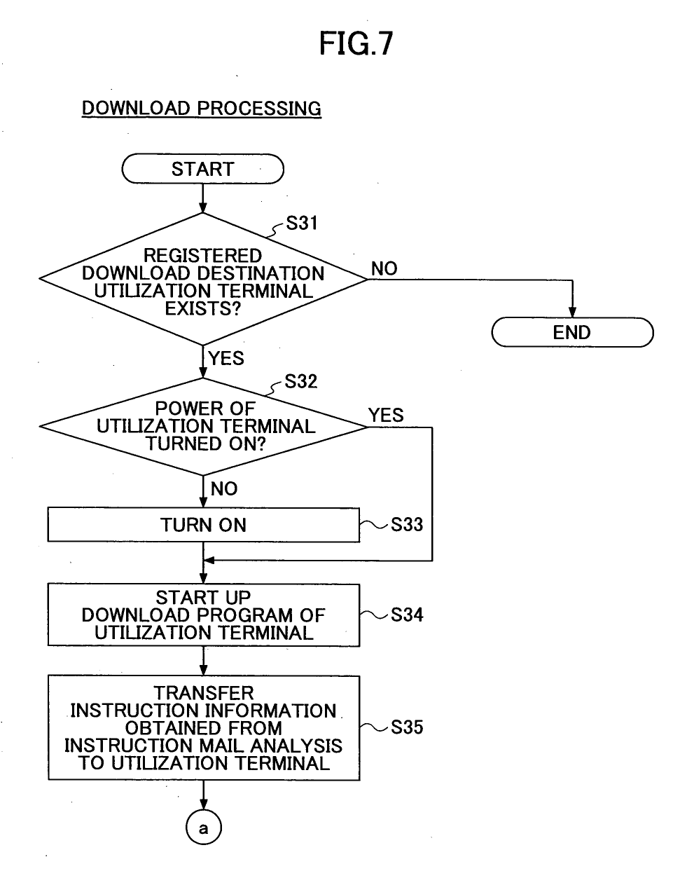

Next, with reference to FIGS. 7 through 9, operation of the home server 300 and the content utilization terminal 400 is described for the download processing described with reference to FIG. 4. When a plurality of the content utilization terminals 400 carry out the download processing, the same processing is repeated for each terminal (Step S31). Next, a power supply state of the relevant terminal 400 of the current download destination is checked, and power supply to the terminal is turned on if necessary (Step S32, S33). Then, a predetermined downloading program of the content utilization terminal 400 is started, and the instructions of the instruction electronic mail described with reference to FIG. 6 already received are transmitted to the terminal 400 from the home server 300 (Steps S34, S35).

The content utilization terminal 400 which has received the instructions makes network connection for the URL mentioned in the item ‘service’ included in the instruction electronic mail (Step S36). Then, for a Login request from the server 200 of the connection destination, the content utilization terminal 400 returns therefor, i.e., the above-mentioned item ‘order’ for an account request, and the above-mentioned item ‘pwd’ for a password request (Step S37). After the server authentication, the item ‘license’ is returned for a license key request the from server 200 (Step S38, S39).

Next, from the server 200, the content utilization terminal 400 requests information of a download size (Step S40). The download size returned from the server 200 is applied to check whether or not the available storage capacity of the hard disk is sufficient in the terminal 400 (Step S41). When the available storage capacity is insufficient (No of Step S41), temporary files (i.e., Internet related information, installing related files or such) (Step S42). Then, the available storage capacity is confirmed again (Step S43). When it is still not possible to obtain the sufficient storage capacity in the hard disk or its own, a hard disk of any other content utilization terminal also connected to the home network under the control of the home server 300 is utilized. When the necessary storage capacity is created in the own machine, the relevant address is recorded as the download destination (Step S44).

Next, a CPU state of the own machine, a storage state and a circuit state are checked in the terminal 400 (Step S45). When it is determined therefrom that the own machine already has a high processing load, the relevant download processing should not be carried out. In such a case, the connection with the server 200 is temporarily broken. Then the CPU state, the storage state and the circuit state of the own machine are checked again regularly (Steps S47, S48, S49, S50, S51). As a result, when it is determined that the own machine has entered such a condition that the downloaded operation is permitted (Yes of Step S51), Step S36 is returned to, and the processing after the server Login is repeated.

Then, when it is determined finally that the download is permitted (Yes of Step S46), the content utilization terminal 400 requests instructions for starting downloading from the server 200 (Step S52). Then, download of the file is started from the server 200 with the use of a downloaded file name retuned from the server 200 (Step S53, S54). After the download is completed, a notice of end is sent to the home server 300 (Step S55).

Thus, according to the first embodiment of the present invention, a function of an electronic mail is utilized to communicate of information required for actual download of the contents. Then, by analyzing the electronic mail, it is possible to positively achieve necessary communications, and thereby, the user can positively cause the content utilization terminal located at the empty home to carry out the content download processing even from a remote position.

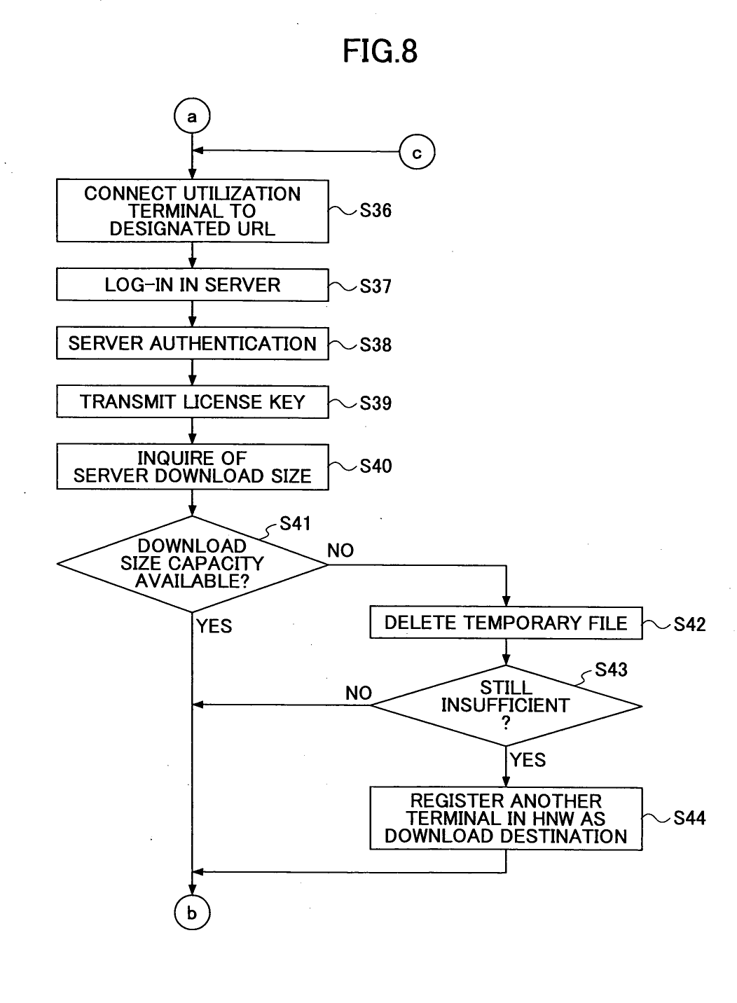

Further, before starting actual download processing, the available storage capacity of the hard disk of the own machine is checked in the terminal 400. If the available capacity is insufficient, predetermined processing such as deletion of temporary files or such is carried out for creating an extra capacity (Steps S40 through S44 of FIG. 8). Thereby, it is possible to avoid the actual download processing from being failed in due to lack of a sufficient storage capacity or such.

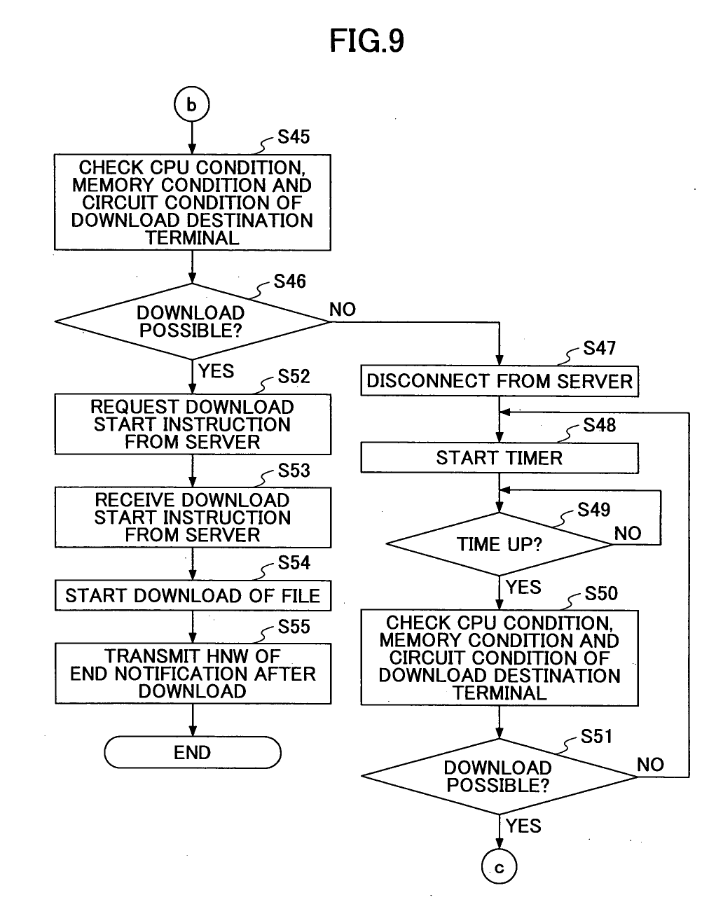

Further, the conditions of the CPU and so forth are also checked as mentioned above. For example, if the relevant terminal is used by another user for a different purpose, or such, and thus no surplus processing capability remains in the relevant terminal 400, the connection with the server 200 is broken temporarily, and after that, the same conditions are checked again periodically (Steps S45 through S51 of FIG. 9). Thereby, it is possible to avoid obstruction to another user. Such a procedure is effective in such a remote operation environment.

Further, the license key information obtained from the purchase phase is required for permission of actual utilization of the downloaded contents. Accordingly, even the terminal in which the contents are downloaded is a common terminal shared by many users, it is possible to positively avoid usage of the contents by an unauthorized person. As mentioned above, the authorized user has the license key information in the own instruction terminal 100, applies the same upon actually utilizing the relevant downloaded contents.

It is not necessarily required to establish such a home network as that in which the home server 300 is provided as mentioned above. For example, if the content utilization terminal 400 is in a state in which power supply is always turned on, the content utilization terminal 400 can directly carry out the operation starting from the reception of the download instructions from the instruction terminal 100 (Steps S301, S302 and S313 of FIGS. 3 and 4). In such a case, the power turning on operation in Step S311 and the download instruction operation in Step S312 are not needed.

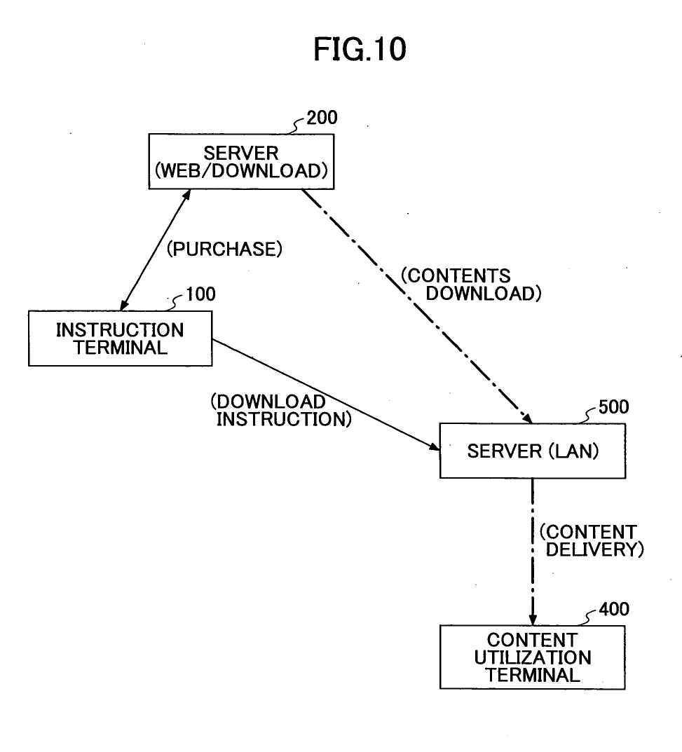

A remote downloading system according to a second embodiment of the present invention is described next, with reference to FIGS. 10 through 13.

Basically, most of a configuration of the second embodiment is the same as that of the first embodiment described above, the same reference numerals are given to parts/steps/operation the same as those of the first embodiment, and description thereof is omitted.

FIG. 10 shows an outline configuration of the system. This embodiment is different from the first embodiment in that, for example, the system is applied to a situation in which many users share downloaded contents in a facility such as a school, a library, or such as mentioned above.

In FIG. 10, a part, in which a content delivery server 200 is accessed by an instruction terminal 100 operated by a user (in this case, who is assumed as being a representative or a manager of the many users who share the downloaded contents), and a content purchase procedure is carried out, is the same as that of the first embodiment.

The instruction terminal 100 then transmits instructions for download, via an electronic mail for server 500 (referred to as a ‘content reception server’) of a LAN established in the facility such as a school, a library or such utilizing the contents. The content reception server 500 which has received the instructions downloads the relevant contents from the content delivery server 200 according to the instructions automatically. Afterwards, the contents for which the download is finished are delivered to the content utilization terminal 400 of each user from the content reception server 500 at an arbitrary timing. Although the single content utilization terminal 400 is shown in FIG. 10, there can be actually the many content utilization terminals 400 connected with the content reception server 500 via the common LAN, and, for the respective ones of these individuals, the same contents are delivered from the content reception server 500.

By establishing such a system, the representative or manager of the facility should not necessarily stay in the facility when the desired contents are thus downloaded actually. Even from the outside of the facility, the representative or manger can positively download the contents in the content reception server 500 located within the facility automatically, and also, can delver the thus-once-downloaded contents to the many respective content utilization terminals 400 automatically.

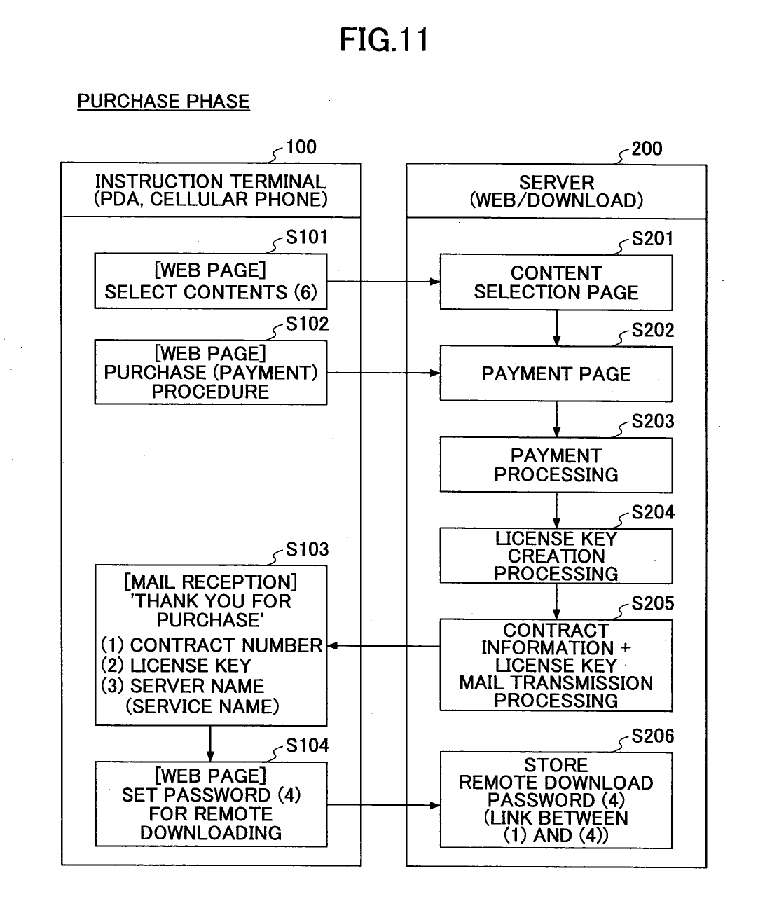

The remote downloading system according to the second embodiment of the present invention are described with reference to FIGS. 11 through 13 in detail.

FIG. 11 is a figure illustrating a purchase phase in the embodiment. Because the contents of this phase are the same as those of the first embodiment described with reference to FIG. 2, duplicate description is omitted.

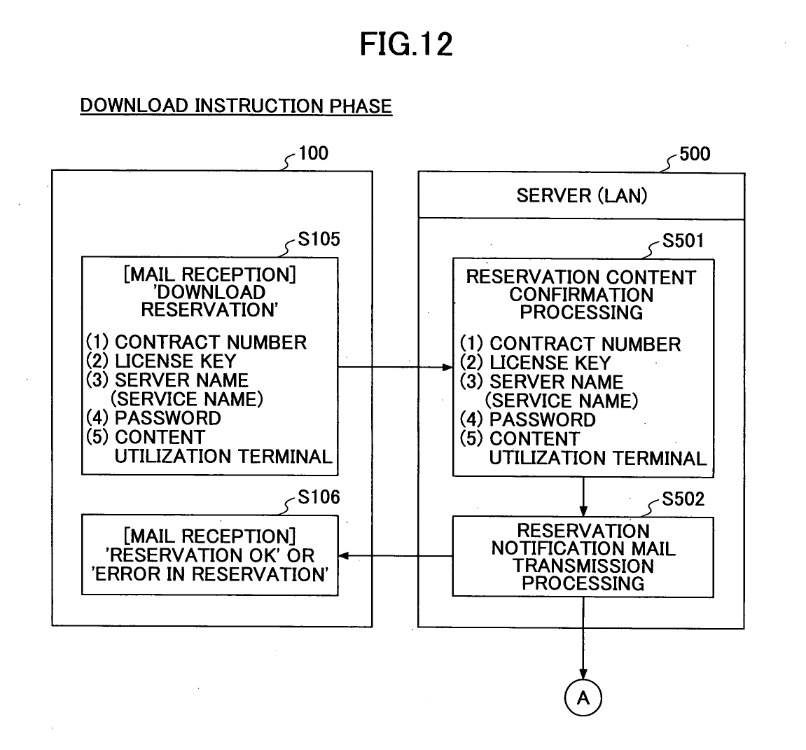

FIG. 12 is a figure illustrating a download instruction phase in the embodiment. Because the contents of this phase are also the same as those of the first embodiment described above with reference to FIG. 3, except that, a part, which receives download instructions from the instruction terminal 100 is changed from the home server 300 into the content reception server (LAN server) 500, duplicate description is omitted. It is noted that Steps S501 and S502 correspond to Steps S301 and S302 of FIG. 3, respectively.

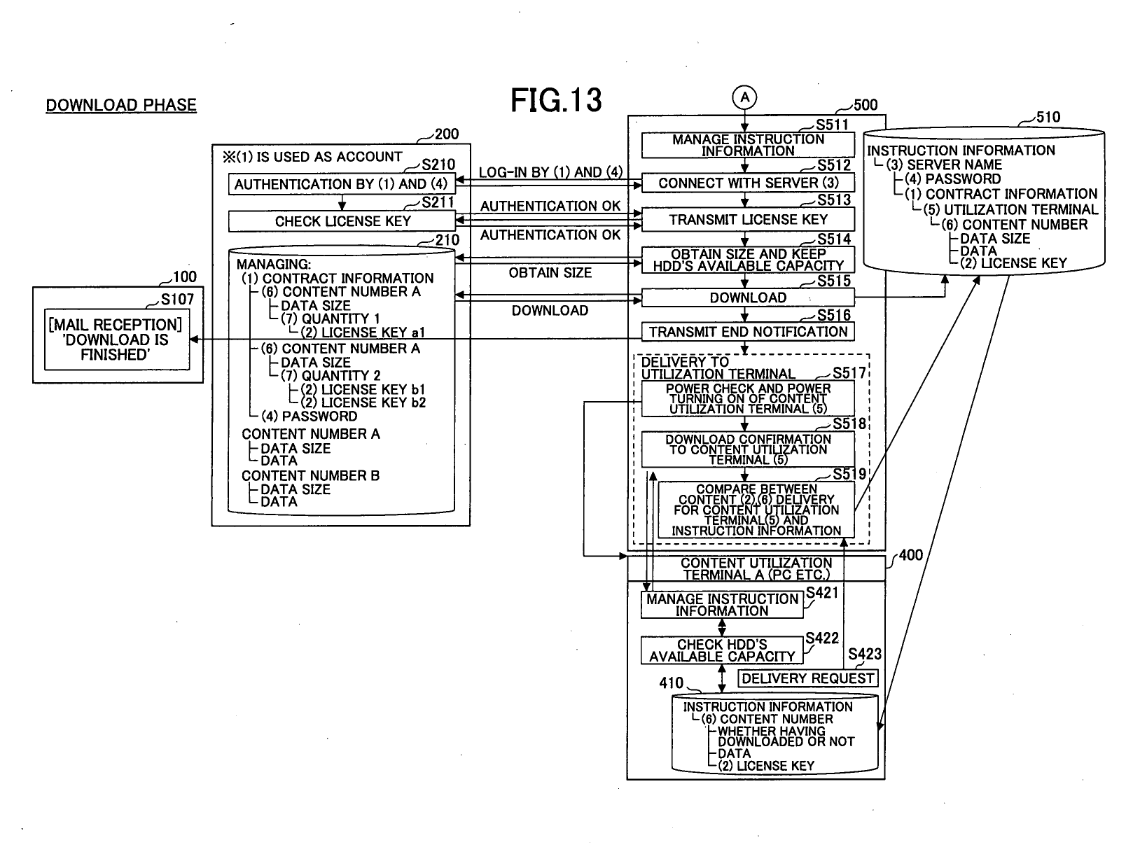

Next, with reference to FIG. 13, a download phase is described.

The content reception server 500 which has received the downloading information obtained in the download instruction phase manages this in a storage device 510 of its own (Step S511). Then, the content reception server 500 accesses a content delivery server 200 (actually, a URL of the server, or such) according to a server name included in the thus-managed downloading information (Step S512). At this time, Login operation is carried out from the content reception server 500 by applying an order number and a password also included in the downloading information.

Authentication processing is therewith carried out by the content delivery server 200 which has received them, and the Login is accepted (Step S210). The content reception server 500 then transmits license key information also included in the downloading information to the content delivery server 200 in the same way afterwards (Step S513). The content delivery server 200 having received it checks the license key information (Step S211). As a result, authentication processing of this content delivery destination by the content delivery server 200 is completed.

Next, a size of the contents that are going to be downloaded is obtained from the content delivery server 200 by the content reception server 500 (Step S514), and, according to the thus-obtained information, processing to keep a storage area of a hard disk of the own machine is carried out.

The same as in the first embodiment, necessary information is managed in the content delivery server 200 with the use of an own storage device 210, for each contract, obtained as a result of commercial transaction of purchase procedure made by each user. A content number concerning each purchase, a data size, a purchase quantity, license key information and a password set by each user are included in the managed information.

Next, download of relevant contents is carried by the content reception server 500 (Step S516). On this occasion, it is possible to identify the contents to be downloaded by an “order number” (an order number handled in S105 of FIG. 12) included in the instruction information transmitted via an electronic mail from the instruction terminal 100 in the download instruction phase of FIG. 12.

The content reception server 500 transmits a download end notice message for the instruction terminal 100 after the relevant download is finished (Step S516). The instruction terminal 100 which has thus received this message displays the same on its display device for the user.

Next, the content reception server 500 determines whether power supply of the content utilization terminal 400 designated by information included in the instruction information is turned on. In the case of not turned on, operation to turn on the power supply is carried out by the content reception server 500 (Step S517). Next, for the content utilization terminal 400 which thus has been started up and entered an operable state, a signal to inquire as to whether or not reception of the relevant contents is actually requested (Step S518).

The relevant content utilization terminal 400 which has received this signal manages it in its own storage device 410 as delivery information (Step S421). The content number to identify the contents (which are already downloaded in the content reception server 500 as mentioned above) and the license key information (included in the instruction information) are included in the above-mentioned signal and then in the delivery information. Then, the content utilization terminal 400 checks an available storage capacity of a hard disk of its own (Step S422). In this case, the same as in the first embodiment, creation of an extra storage capacity is tried by deletion of temporary files or such in the case of lack of the available storage capacity. When the lack of available storage capacity is still maintained even after the trial, the content utilization terminal 400 does not actually request a delivery of the contents from the content reception server 500 at this time.

Then, when an appropriate available storage capacity of the hard disk is finally secured, a signal of requesting a delivery from the content reception server 500 is transmitted. The above-mentioned delivery information is also included in this signal, and the content reception server 500 which has thus received this signal delivers the contents to the content utilization terminal 400. At this time, before actually delivering the contents, the content reception server 500 compares the delivery information transmitted from the content utilization terminal 400 accompanying the delivery request with the instruction information of the contents which the own machine manages. Any terminal other than the authorized content utilization terminal 400 does not have the license key information included in the delivery information. Accordingly, even if a delivery request is sent from another terminal, the license key information agreement does not hold between the delivery request received from the terminal and the instruction information already received from the instruction terminal 100 in the download instruction phase. As a result, the contents are prevented from being delivered to any terminal other than the authorized content utilization terminal 400.

Processing to deliver the contents to the content utilization terminal 400 starting from the above-mentioned Step S517 is repeated for the number of the respective content utilization terminals 400 (i.e., those designated as the “content utilization terminals” in the instruction information shown in FIG. 12).

In addition, information indicating whether the contents have been already delivered to the content utilization terminal 400 from the content utilization terminal 400 is stored in the delivery information managed in the storage device of each of the content utilization terminals 400. As to actual utilization of the thus-delivered contents in each content utilization terminal 400, it is determined whether or not actual utilization is possible, from the delivery information managed in the own machine. Then, for example, when delivery cannot be carried out due to lack of the available storage capacity checked in Step S422, this matter is recognized from the delivery information. Then, in response thereto, the content utilization terminal 400 again communicates with the content reception server 500, and carries out operation to request delivery of the contents therefrom.

In addition, preferably, each content utilization terminal 400 may also automatically carry out processing of installing software or such in the own machine when the contents thus delivered correspond to the software or such, at the same time when having the contents delivered thereto in response to reception of the delivery confirmation notice in Step S518. As a result, the user can immediately utilize the software thus already installed, and thus, it is possible to further improve the convenience of the user.

According to the second embodiment of the present invention, the functions/advantages the same as those in the above-described first embodiment can be obtained. In addition, the contents are once downloaded from the content delivery server by the LAN server (content reception server) 500 as a representative, and after that, the thus-obtained contents are delivered to each content utilization terminal 400 at an appropriate timing. In this configuration, particular delivery processing carried out for each content utilization terminal 400 after the contents are downloaded in the LAN server 500 is carried out in a manner of local data exchange by means of the LAN. Accordingly, data transfer can be carried out easily and positively in comparison to the case of data transfer by means of a wide-band communication network such as the Internet.

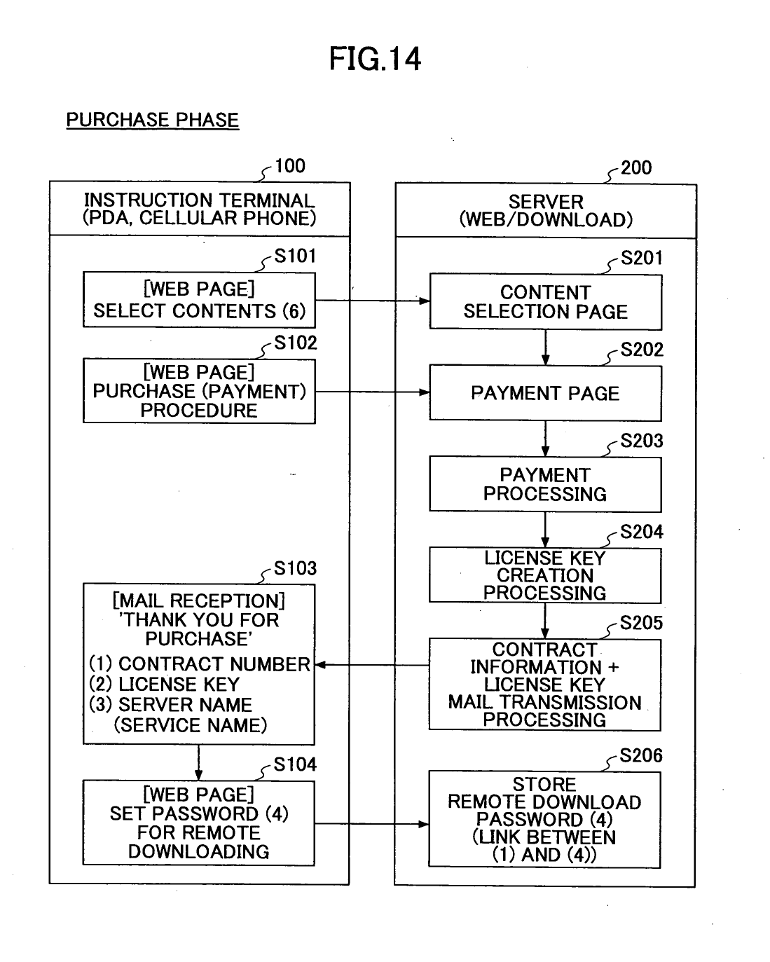

A remote downloading system according to a third embodiment of the present invention is described next with reference to FIGS. 14 through 16. Basically the same as the above-described second embodiment, the remote downloading system according to the third embodiment is applicable to a case where the downloaded contents are shared by many users in a facility such as a school, a library, or such. Basic configuration and operation are the same as those of the second embodiment, duplicate description is omitted, and description is made mainly for points different from the second embodiment.

According to the second embodiment, the content reception server 500 carries out the content delivery processing starting from the operation of turning on the power of the content utilization terminal 400 (Step S517) in a real-time manner, after the contents are downloaded from the content delivery server 200. In contrast thereto, according to the third embodiment, after the contents are downloaded from the content delivery server 200, the content reception server 500 merely transmits an electronic mail to each content utilization terminal 400 including a notice that preparation to deliver the contents has been completed (Step S521). At this time, the content reception server 500 has finished preparation operation for delivery, and, after that, until an actual request to delivery is sent from each content utilization terminal 400, the content reception server 500 does not carry out operation to actually deliver the contents. By providing such a configuration, actual delivery of the contents is carried out only in timing depending on a particular situation of each content utilization terminal 400. Accordingly, actual delivery is carried out at a convenient timing for each content utilization terminal 400. As a result, improvement in a work efficiency and a terminal's usage efficiency in each content utilization terminal and each user can be achieved.

FIG. 14 is a figure illustrating a purchase phase in the third embodiment. Since the contents of the phase are the same as those of the first embodiment described above with reference to FIG. 2, duplicate description is omitted.

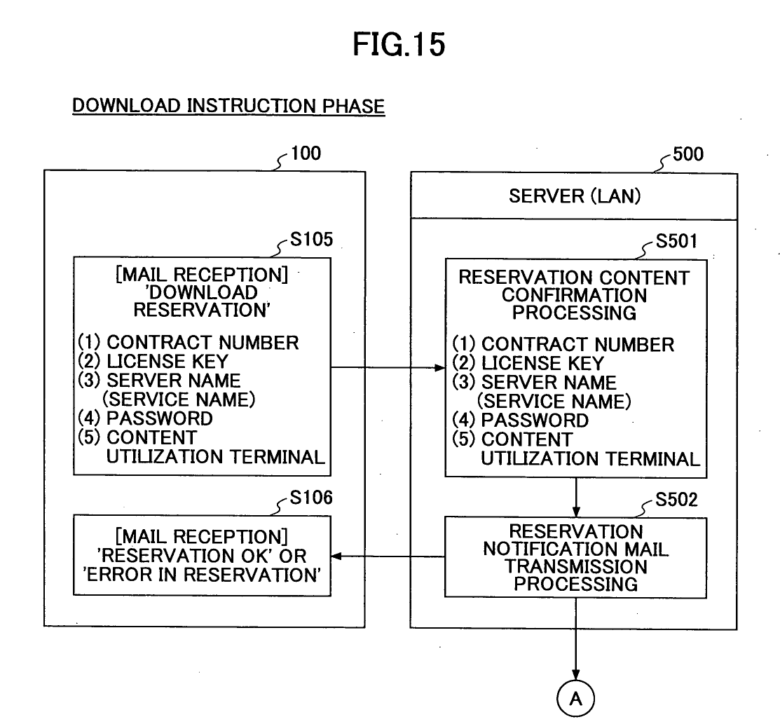

FIG. 15 is a figure illustrating a download instruction phase in the third embodiment. Since the contents of this phase are also the same as those of the first embodiment described above with reference to FIG. 3, except that, a part receiving the download instructions from the instruction terminal 100 is changed from the home server 300 to the content reception server (LAN server) 500 as in the second embodiment, duplicate description is omitted. It is noted that Steps S501 and S502 correspond to Steps S301 and S302 of FIG. 3, respectively.

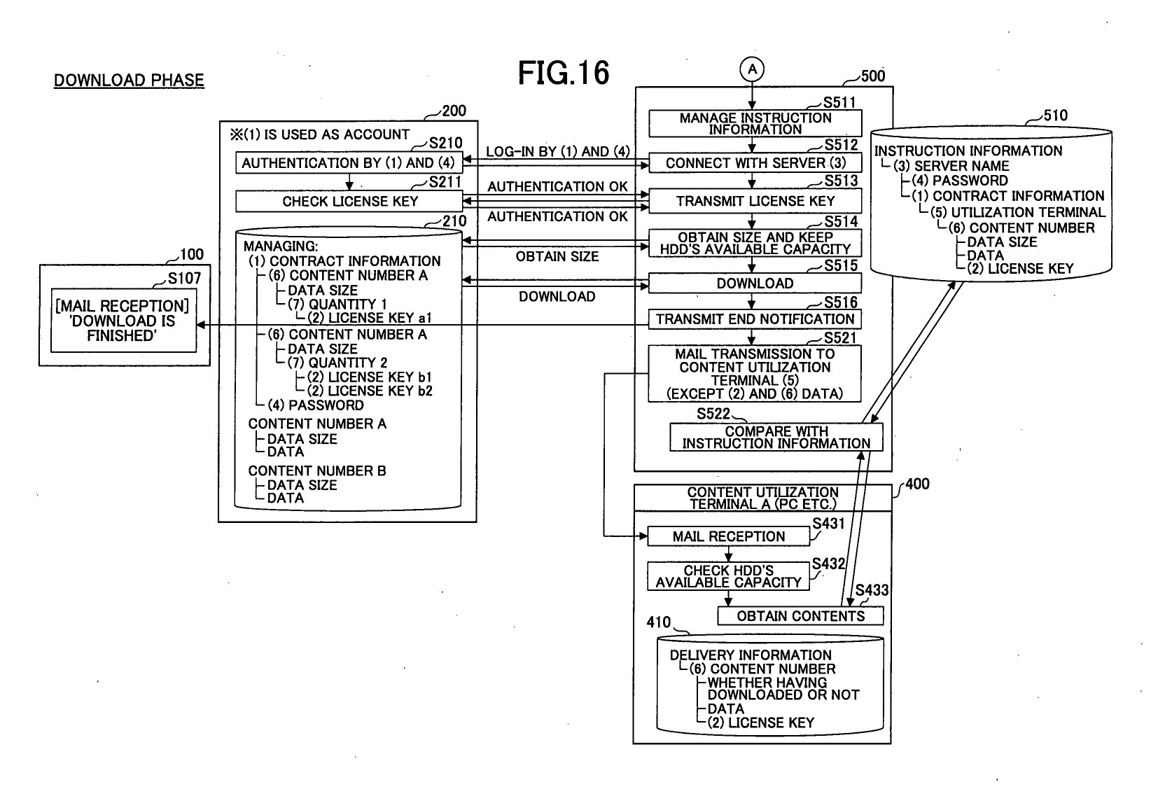

FIG. 16 is a figure illustrating a download phase in the third embodiment. The download phase in the third embodiment is the same as the download phase in the second embodiment described with reference to FIG. 13 basically. Thus, duplicate description is omitted, and only different parts are described below.

That is, instead of the delivery processing (Steps S517 through S519) in the second embodiment shown in FIG. 13, merely an electronic mail having a message that a preparation for delivery of the contents is completed is transmitted by the content reception server 500 for each of the relevant content utilization terminals 400 (Step S521). In this case, the message of the electronic mail does not include ‘the license key information’ included in the information received from the instruction terminal 100 in the download instruction phase of FIG. 15 and the identification information for the contents for which the download has been already finished in Step S515. Thereby, even when the content utilization terminal 400 is operated by a person other than the authorized user, delivery of the contents is not permitted.

That is, when delivery of the contents is made from the content reception server 500, a manager or such who actually has the instruction terminal 100 applies the license key information, which has been obtained from the content delivery server 200 in the purchase phase of FIG. 14 and managed in the instruction terminal 100. As a result, actual transmission of the contents from the content reception sever is permissible with the use of the license key information.

After that, the content utilization terminal 400 which thus has received the electronic mail checks an available storage capacity in a hard disk of its own (Step S431, S432). In this case, the same as the first embodiment, creation of an extra storage capacity is tried by means of deletion of temporary files or such in the case of lack of the available storage capacity. Then, the content utilization terminal 400 does not request transmission of the contents from the content reception server 500 when the situation of the lack of sufficient available storage capacity is maintained even after taking the counter measures.

In addition, when the necessary available storage capacity of the hard disk is finally secured, a signal of requesting transmission of the contents is transmitted for the content reception server 500 from the content utilization terminal 400. This signal includes the license key information obtained from the instruction terminal 100 of the manager or such, the content reception server 500 which has thus received this signal then transmits the contents to the relevant content utilization terminal 400 accordingly (Step S433). In addition, At this time, before the actual transmission, the license key information included in the signal transmitted from the content utilization terminal 400 is compared with the license key information included in the instruction information of the relevant contents managed by the content reception server 500. Then, when the comparison results in agreement of the license key information, the transmission of the contents is allowed by the content receptions server 500. Thus, it is possible to prevent the contents from being illegally obtained by any person other than the authorized user.

In addition, as mentioned above for the second embodiment, preferably, each content utilization terminal 400 may also automatically carry out processing of installing software or such in the own machine when the contents thus delivered correspond to the software or such, at the same time when having the contents delivered thereto in response to reception of the delivery configuration notice in Step S518. As a result, the user can immediately utilize the software thus already installed, and thus, it is possible to further improve the convenience of the user.

According to the third embodiment of the present invention, the functions/advantages the same as those in the above-described first and second embodiments can be obtained. In addition, as mentioned above, actual acquisition of the contents in each content utilization terminal 400 is carried out at a timing convenient for the relevant terminal, and thus, it is possible to improve the work efficiency and the terminal utilization efficiency. Furthermore, since the license key information and so forth are not included in the content preparation completion notice (Step S521) as mentioned above, it is possible to effectively avoid illegal acquisition of the contents by an unauthorized person.

In addition, the LAN server (content reception server) 500 may be realized in a personal computer in each of the second and third embodiments described above. In addition, one of the content utilization terminals 400 may have the function of the content reception server 500.

In addition, the content utilization terminal 400 may be realized in a form of a PDA or a cellular phone, other than the personal computer as in the above-described embodiments. In that case, it is possible to effectively shorten a time required for downloading the contents, by determining a timing of actually carrying out the downloading to a timing at which a connection load amount (traffic) of the relevant content delivery server 200 is small, while monitoring the actual traffic.

In addition, operation of checking the available storage capacity of the storage device of the content utilization terminal 400 may be carried out rather by the home server 300 or the content reception server 500.

In a like manner, necessary control operation of the above-mentioned temporary storage of the contents in another terminal in a case of lack of the available storage capacity may also be carried out by the home server 300 or the content reception server 500.

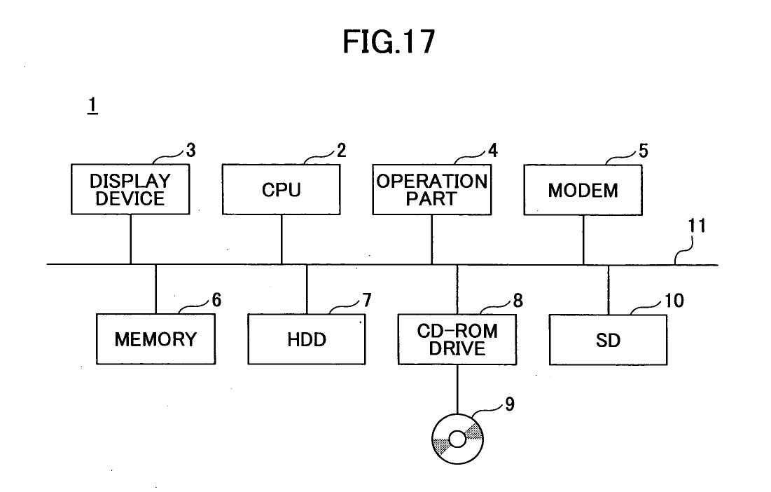

FIG. 17 is a block diagram showing a hardware configuration example of each of the instruction terminal 100, the home server 300, the content reception server 500 and the content utilization terminal 400 in the respective embodiments described above.

As shown, each apparatus includes a CPU 2; an operation part 4 such as a keyboard and so forth for a user to carry out inputting instructions, data or such; a display device 3 for displaying various sorts of data to the user; a modem 5 as a communication functional device; a memory 6 for storing various sorts of data; a hard disk device (HDD) 7; a CD-ROM drive 8; and an SD cared device 10. These parts are electrically connected mutually via a bus 11. Any of the hard disk device (HDD) 7. the CD-ROM drive 8 and the SD cared device 10, for storing data, may be omitted in consideration of trade-off among the functional capability of each apparatus, the outside dimensions thereof, the gross weight thereof and so forth.

Each function executed by each apparatus may be realized as a result of a program including corresponding respective instructions being previously produced; it being then written in a CD-ROM 9, an SD card or such; it being read out therefrom by means of a respective one of the CD-ROM drive 8, SD card device 10 and so forth; and then it is actually executed by the CPU 2. Similarly, it is also possible to realize each function of each apparatus as a result of downloading the same program through a communication network such as the Internet, and installing the same in the HDD 7.

In addition, the instruction terminal 100 of each of the respective embodiments corresponds to an operation apparatus; the content delivery server 200 corresponds to a data delivery apparatus; the home server 300 corresponds a managing apparatus; the content utilization terminal 400 corresponds an information processing apparatus or a data utilization device; and the content reception server 500 corresponds a data receiving apparatus.

The present invention is not limited to the above-described embodiments, and variations and modifications may be made without departing from the basic concept of the present invention claimed below.

The present application is based on Japanese Priority Application No. 2005-035223, filed on Feb. 10, 2005, the entire contents of which are hereby incorporated herein by reference.

What is claimed is:

1. A remote downloading system comprising:
a data delivery apparatus delivering data;
an operation apparatus to which a user carries out operation for obtaining data from the data delivery apparatus; and
a data utilization apparatus for downloading the data obtained by the operation of the operation apparatus, wherein:
said operation apparatus comprises: a downloading information obtaining part obtaining downloading information required for downloading the data from the data delivery apparatus in response to data obtaining operation carried out thereon; and a downloading information transmitting part transmitting the thus-obtained downloading information to the data utilization apparatus; and
said data utilization apparatus applies the downloading information thus transmitted from the operation apparatus, and downloads the relevant data from the data delivery apparatus.

2. The remote downloading system as claimed in claim 1, wherein:
the downloading information obtaining part and the downloading information transmitting part have communication functions, and carry out the data obtaining processing from the data delivery apparatus and the downloading information transmitting processing to the data utilization apparatus by means of electronic mails.

3. The remote downloading system as claimed in claim 1, wherein:
said data utilization apparatus determines, before carrying out data downloading, whether or not a predetermined storage has a storage space for downloading the relevant data, carries out deletion of a temporary folder so as to obtain the storage space when it is determined that the storage space is insufficient, and, then, when the storage space is still insufficient even after that, the data utilization apparatus carries out downloading the relevant data with the use of another storage.

4. The remote downloading system as claimed in claim 1, wherein:
said data utilization apparatus comprises an information processing apparatus actually downloading thereto data and a managing apparatus managing the information processing apparatus; and
said managing apparatus determines, before transmitting the downloading information transmitted from the downloading information transmitting part of the operation apparatus to the information processing apparatus and causing the information processing apparatus to carry out downloading the data, whether or not a storage of the information processing apparatus has a storage space for downloading the relevant data, carries out deletion of a temporary folder so as to obtain the storage space when it is determined that the storage space is insufficient, and, then, when the storage space is still insufficient even after that, the data managing apparatus carries out downloading the relevant data with the use of another storage which operates under the control of the managing apparatus.

5. The remote downloading system as claimed in claim 1, wherein:
said data utilization apparatus determines, before carrying out data downloading, whether or not downloading of relevant data is carried out at the present time, based on an operation condition of the apparatus, and, carries out the same determination again after an elapse of a predetermined time interval when the downloading operation is not actually carried out at the present time according the current determination result.

6. The remote downloading system as claimed in claim 1, wherein:
said data utilization apparatus comprises an information processing apparatus actually downloading thereto data and a managing apparatus managing the information processing apparatus; and
said managing apparatus determines, before transmitting the downloading information transmitted from the downloading information transmitting part of the operation apparatus to the information processing apparatus and causing the information processing apparatus to carry out downloading data, whether or not downloading of relevant data is carried out at the present time based on an operation condition of the information processing apparatus, and, carries out the same determination again after an elapse of a predetermined time interval when the downloading operation is not actually carried out at the present time according the current determination result.

7. The remote downloading system as claimed in claim 1, wherein:
said data utilization apparatus comprises an information processing apparatus with which the downloaded data is directly utilized, and a receiving apparatus to which the data is once downloaded from the data delivery apparatus; and
said data receiving apparatus downloads the data from the data delivery apparatus with the use of the downloading information transmitted from the downloading information transmitting part of the operation apparatus, and after that, delivers the same data to the information processing apparatus.

8. The remote downloading system as claimed in claim 7, wherein:
before delivering the once downloaded data to the information processing apparatus, the data receiving apparatus determines whether or not downloading of the relevant data is carried out at the present time based on an operation condition of the information processing apparatus, and, carries out the same determination again after an elapse of a predetermined time interval when the downloading operation is not actually carried out at the present time according the current determination result.

9. The remote downloading system as claimed in claim 1, wherein:
said data utilization apparatus comprises an information processing apparatus with which the downloaded data is directly utilized, and a receiving apparatus to which the data is once downloaded from the data delivery apparatus; and
said information processing apparatus is configured to receive, at an arbitrary timing, from the data receiving apparatus, the relevant data once downloaded to the data receiving apparatus with the use of the downloading information transmitted from the downloading information transmitting part of the operation apparatus.

10. The remote downloading system as claimed in claim 9, wherein:
before receiving the data from the data receiving apparatus, the information processing apparatus determines whether or not reception of the relevant data is carried out at the present time based on an operation condition of the own apparatus, and, carries out the same determination again after an elapse of a predetermined time interval when the downloading operation is not actually carried out at the present time according the current determination result.

11. The remote downloading system as claimed in claim 1, wherein:
the downloading information required for data downloading comprises at least one of a log-in password to be applied for the data delivery apparatus and license key information required for using the relevant data.

12. A managing apparatus managing an information processing apparatus which downloads data from a data delivery apparatus, comprising:
a downloading information receiving part receiving downloading information required for downloading data, which downloading information is one obtained as a result of data obtaining operation being carried out by a user on an operation apparatus; and
a part causing the information processing apparatus to download data from the data delivery apparatus with the use of the downloading information.

13. The managing apparatus as claimed in claim 12, wherein:
said downloading information receiving part has a communication function, and an electronic mail is applied for receiving the downloading information from the operation apparatus.

14. The managing apparatus as claimed in claim 12, further comprising a part of determining, before data downloading is made to be carried out by the information processing apparatus, whether or not said information processing apparatus has a sufficient storage space for downloading the relevant data, carrying out deletion of a temporary folder so as to obtain the storage space when it is determined that the storage space is insufficient, and, then, when the storage space is still insufficient even after that, said part carrying out downloading of the relevant data with the use of another information processing apparatus.

15. The managing apparatus as claimed in claim 12, further comprising a part of determining, when transmitting the downloading information transmitted from the downloading information transmitting part of the operation apparatus to the information processing apparatus with which the information processing apparatus is made to download the relevant data, whether or not downloading of the relevant data is carried out at the present time based on an operation condition of the information processing apparatus, and, carrying out the same determination again after an elapse of a predetermined time interval when the information processing apparatus is not actually made to download the relevant data at the present time according the current determination result.

16. The managing apparatus as claimed in claim 12, wherein:
the downloading information required for data downloading comprises at least one of a log-in password to be applied for the data delivery apparatus and license key information required for using the relevant data.

17. A data receiving apparatus downloading data from a data delivery apparatus, and delivering the same to a predetermined information processing apparatus, comprising:
a downloading information receiving part receiving downloading information, which is required for downloading data, and is obtained as a result of a user carrying out data obtaining operation on the data delivery apparatus by means of a predetermined operating terminal; and
a part downloading the data from the data delivery apparatus with the use of the downloading information.

18. The data receiving apparatus as claimed in claim 17, wherein:
said downloading information receiving part has a communication function, and carries out reception of the downloading information from the operating terminal by means of an electronic mail.

19. The data receiving apparatus as claimed in claim 17, further comprising a part determining, before carrying out data downloading, whether or not there is a sufficient storage space for downloading the relevant data, carrying out deletion of a temporary folder so as to obtain the storage space when it is determined that the storage space is insufficient, and, then, when the storage space is still insufficient even after that, said part carrying out downloading of the relevant data with the use of another information processing apparatus.

20. The data receiving apparatus as claimed in claim 17, further comprising a part of determining, before delivering once downloaded information to the predetermined information processing apparatus, whether or not delivery of the relevant data is carried out at the present time based on an operation condition of the information processing apparatus, and, carrying out the same determination again after an elapse of a predetermined time interval when actual deliver of the relevant data to the predetermined information processing apparatus is not carried out at the present time according the current determination result.

21. The data receiving apparatus as claimed in claim 17, wherein:
the downloading information required for data downloading comprises at least one of a log-in password to be applied for the data delivery apparatus and license key information required for using the relevant data.

22. An operation apparatus applied by a user to carry out data obtaining operation on a data delivery apparatus, comprising:
a downloading information obtaining part obtaining, in response to the data obtaining operation, downloading information required for actually downloading data from the data delivery apparatus; and
a downloading information transmitting part transmitting the thus-obtained downloading information to a predetermined data utilization apparatus.

23. The operation apparatus as claimed in claim 22, wherein:
said downloading information obtaining part and said downloading information transmitting part have communication functions, and carry out the data obtaining processing on the data delivery apparatus and the downloading information transmitting processing to the data utilization apparatus by means of electronic mails.

24. An information processing apparatus receiving data via a data receiving apparatus delivered from a data delivery apparatus with the use of downloading information, which is required for downloading the data, and is obtained as a result of a user carrying out data obtaining operation on the data delivery apparatus by applying an operation apparatus, comprising:
a part determining, before receiving the data delivered from the data receiving apparatus, whether or not receiving of the relevant data delivered from the data receiving apparatus at the present time based on an operation condition of the own machine, and, carrying out the same determination again after an elapse of a predetermined time interval when actual deliver of the relevant data from the data receiving apparatus is not carried out at the present time according the current determination result.

25. A computer readable information recording medium storing therein a program comprising instructions for causing a computer acting as a managing apparatus managing an information processing apparatus which downloads data from a data delivery apparatus, to act as:
a downloading information receiving part receiving downloading information required for downloading data, which downloading information is one obtained as a result of data obtaining operation being carried out by a user on an operation apparatus for the data delivery apparatus; and
a part causing the information processing apparatus to download data from the data delivery apparatus with the use of the downloading information.

26. The computer readable information recording medium as claimed in claim 25, said program being configured in such a manner that:
said downloading information receiving part has a communication function, and an electronic mail is applied for receiving the downloading information from the operation apparatus.

27. The computer readable information recording medium storing as claimed in claim 25, said program further comprising instructions for causing the computer to further act as a part of determining, before data downloading is made to be carried out by the information processing apparatus, whether or not said information processing apparatus has a sufficient storage space for downloading the relevant data, carrying out deletion of a temporary folder so as to obtain the storage space when it is determined that the storage space is insufficient, and, then, when the storage space is still insufficient even after that, said part carrying out downloading of the relevant data with the use of another information processing apparatus.

28. The computer readable information recording medium as claimed in claim 25, said program further comprising instructions for causing the computer to further act as a part of determining, when transmitting the downloading information transmitted from a downloading information transmitting part of the operation apparatus to the information processing apparatus with which the information processing apparatus is made to download the relevant data, whether or not downloading of the relevant data is carried out at the present time based on an operation condition of the information processing apparatus, and, carrying out the same determination again after an elapse of a predetermined time interval when the information processing apparatus is not actually made to download the relevant data at the present time according the current determination result.

29. The computer readable information recording medium as claimed in claim 25, said program being configured in such a manner that:
the downloading information required for data downloading comprises at least one of a log-in password to be applied for the data delivery apparatus and license key information required for using the relevant data.

30. A computer readable information recording medium storing therein a program comprising instructions to cause a computer acting as a data receiving apparatus downloading data from a data delivery apparatus, and delivering the same to a predetermined information processing apparatus, to act as:
a downloading information receiving part receiving downloading information, which is required for downloading data, and is obtained as a result of a user carrying out data obtaining operation on the data delivery apparatus by means of a predetermined operating terminal; and
a part downloading the data from the data delivery apparatus with the use of the downloading information.

31. The computer readable information recording medium as claimed in claim 30, said program being configured in such a manner that:
said downloading information receiving part has a communication function, and carries out reception of the downloading information from the operating terminal by means of an electronic mail.

32. The computer readable information recording medium as claimed in claim 30, said program further comprising instructions to cause the computer to act as a part determining, before carrying out data downloading, whether or not there is a sufficient storage space for downloading the relevant data, carrying out deletion of a temporary folder so as to obtain the storage space when it is determined that the storage space is insufficient, and, then, when the storage space is still insufficient even after that, said part carrying out downloading of the relevant data with the use of another information processing apparatus.

33. The computer readable information recording medium as claimed in claim 30, said program further comprising instructions to cause the computer to further act as a part of determining, before delivering once downloaded information to the predetermined information processing apparatus, whether or not delivery of the relevant data is carried out at the present time based on an operation condition of the information processing apparatus, and, carrying out the same determination again after an elapse of a predetermined time interval when actual deliver of the relevant data to the predetermined information processing apparatus is not carried out at the present time according the current determination result.

34. The computer readable information recording medium as claimed in claim 30, said program being configured in such a manner that:
the downloading information required for data downloading comprises at least one of a log-in password to be applied for the data delivery apparatus and license key information required for using the relevant data.

35. A computer readable information recording medium storing therein a program comprising instructions to cause a computer acting as an operation apparatus applied by a user to carry out data obtaining operation on a data delivery apparatus, to act as:
a downloading information obtaining part obtaining, in response to the data obtaining operation, downloading information required for actually downloading data from the data delivery apparatus; and
a downloading information transmitting part transmitting the thus-obtained downloading information to a predetermined data utilization apparatus.

36. The computer readable information recording medium as claimed in claim 35, said program being configured in such a manner that:
said downloading information obtaining part and said downloading information transmitting part have communication functions, and carry out the data obtaining processing on the data delivery apparatus and the downloading information transmitting processing to the data utilization apparatus by means of an electronic mail.

37. A computer readable information recording medium storing therein a program comprising instructions to cause a computer acting as an information processing apparatus receiving data via a data receiving apparatus delivered from a data delivery apparatus with the use of downloading information, which is required for downloading the data, and is obtained as a result of a user carrying out data obtaining operation on the data delivery apparatus by applying an operation apparatus, to act as:
a part determining, before receiving data delivered from the data receiving apparatus, whether or not receiving the relevant data delivered from the data receiving apparatus at the present time based on an operation condition of the own machine, and, carrying out the same determination again after an elapse of a predetermined time interval when actual deliver of the relevant data from the data receiving apparatus is not carried out at the present time according the current determination result.
